(19) United States
(12) Patent Application Publication
(10) Pub. No.: US 2014/0256440 A1
(43) Pub. Date: Sep. 11, 2014

(54) GAMING MACHINE

(71) Applicant: NOVOMATIC AG, Gumpoldskirchen (AT)

(72) Inventor: Thomas Faul, Kaiserslautern (DE)

(21) Appl. No.: 14/352,789

(22) PCT Filed: Oct. 18, 2012
(86) PCT No.: PCT/EP2012/070619

§ 371 Date: Apr. 18, 2014

(30) Foreign Application Priority Data
Oct. 21, 2011 (DE) 102012054729.0

(51) Int. Cl. A63F 13/40

(52) U.S. Cl. CPC A63F 13/10
USPC 463/36

(57) ABSTRACT

A gaming machine including at least one computer-controlled game device, which is connected to a game progress controlling device, wherein a device is provided for controlling the input and output elements. The device has a control device which is coupled to the game progress controller and is in communication with a master, which communicates in real time via a two-wire connection with input and output elements designed as slaves.

The invention relates to a gaming machine having at least one computer-controlled gaming device that is connected to a game flow control, wherein a device for controlling input and output elements is provided, and to a method for controlling the gaming machine.

In an amusement machine that is known from the prior art, particularly a coin-operated gaming machine, it is necessary for a multiplicity of pushbutton switches and LEDs, which are usually each associated with keys of the pushbutton switches for the purpose of backlighting the latter, to be wired to a controller. This results in a wiring harness, which is disadvantageous not only in view of the relatively high costs. To date, the wiring harness has been coupled to the controller, what is known as a key device, by means of a 40-pin plug connection and has connected the controller to the respective individual LEDs and pushbutton switches by means of separate data and power supply lines. The production of the wiring harness is complex and inflexible, since the wiring harness matches the respective amusement machine and it is not readily possible to implement fast change, which is often necessary in the design phase of an amusement machine.

It is an object of the invention to provide a gaming machine of the type such as at the outset that can be matched inexpensively to changed requirements and for which it is possible to implement fast and reliable actuation of input and output elements given a relatively high level of data integrity.

The invention achieves the object by means of the features of the independent claims.

The features of the subclaims are advantageous refinements.

A gaming machine comprises at least one computer-controlled game device that is connected to a game flow control, wherein a device for controlling input and output elements is provided. The device comprises a controller that is coupled to the game flow control and that is connected to a master that communicates via a two-wire connection in real time with input and output elements in the form of slaves.

Accordingly, the communication no longer takes place via a wiring harness, but rather takes place by means of a type of field bus using a master/slave transmission system via just two lines that have polarity reversal protection, wherein the master can actuate a multiplicity of flexibly arrangeable slaves that are connected to the master by looping through, in star form, tree form or in combinations of these, for example. The topology is freely selectable and hence very flexible to wire. The slaves are naturally physically connected in parallel. The controller is intended to be understood to mean a gaming machine control that transmits game-specific data, or information, to the master and receives data for the slaves from the master, for example.

As is generally known, the slaves have device IDs, that is to say explicit identifiers, with it being possible to allocate a shared device ID to a plurality of pushbutton switches, so that the master recognizes when a key has been pushed for all pushbutton switches having the same device ID when a pushbutton switch has been operated. In this case, it is readily possible to run approximately 60 pushbutton switches, preferably with a total current of up to approximately 4 A, depending on an output stage of the master. Usually, 16 different pushbutton switches (slaves) with their associated LEDs are explicitly actuated. Naturally, a pushbutton switch (slave) can be allocated a new device ID, and the master is provided with automatic feedback from the pushbutton switches (slaves) when they are operational or installed. In one pass, it is possible to address all the slaves having the same device ID, and all the slaves can simultaneously send a response, wherein a plurality of slaves having the same address may be existent, contrary to the prior art. Furthermore, the master recognizes both pushbutton switches (slaves) without device IDs and device IDs that have no associated pushbutton switch (slave). The parity bit and the inverted bit that is sent again mean that the data are existent with twofold redundancy for a Hamming distance of four. Furthermore, data received by the master that describe the existence of a pushbutton switch (slave) are redundantly existent with a Hamming distance of two and data concerning the operation of a pushbutton switch are redundantly existent with a Hamming distance of four. In addition, it is possible to sense and store the number of instances of operation of a pushbutton switch, which means that data about wear are available that can be used as a basis for a decision concerning replacement of a pushbutton switch.

Besides pushbutton switches or LEDs, each slave may also have arbitrary actuators and/or arbitrary sensors associated with it, particularly heat sensors, for example for detecting thermal radiation from a user, acceleration sensors, balance wheels, in order to produce vibrations and the like.

A slave in programmable form can be allocated an arbitrary address, for example. It is also possible to store signal trains, particularly for the purpose of actuating LEDs, for example in a flashing mode or in the form of what is known as a moving picture for animating a user of the gaming machine.

It goes without saying that the features cited above and those that are yet to be explained below can be used not only in the respectively indicated combination but also in other combinations. The framework of the invention is defined only by the claims.

The invention is explained in more detail below using an exemplary embodiment with reference to the associated drawings, in which:

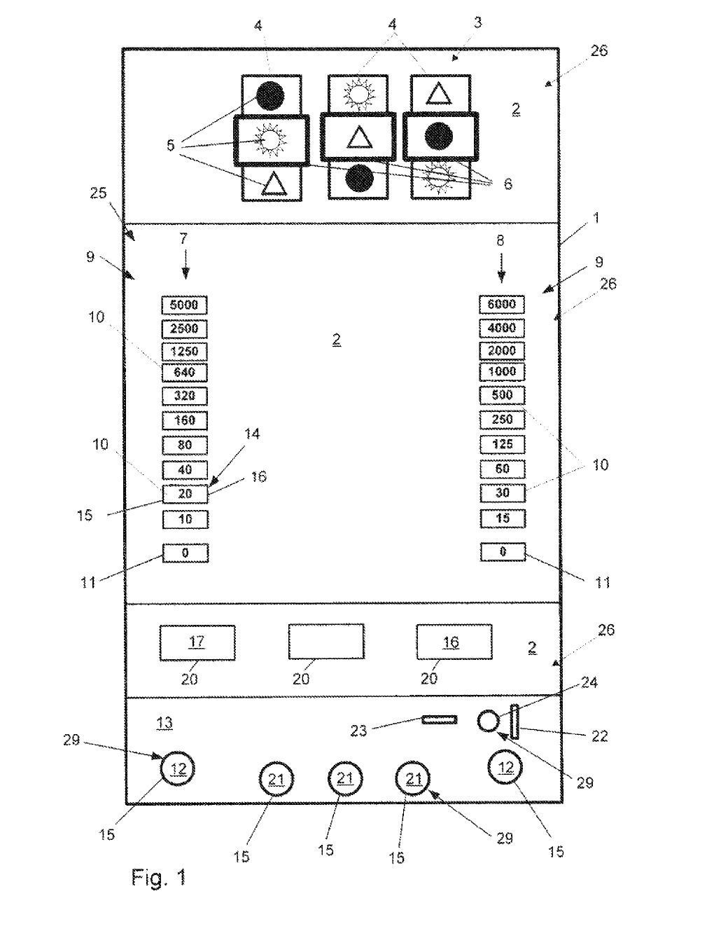

FIG. 1 shows a schematic illustration of a front view of an inventive gaming machine,

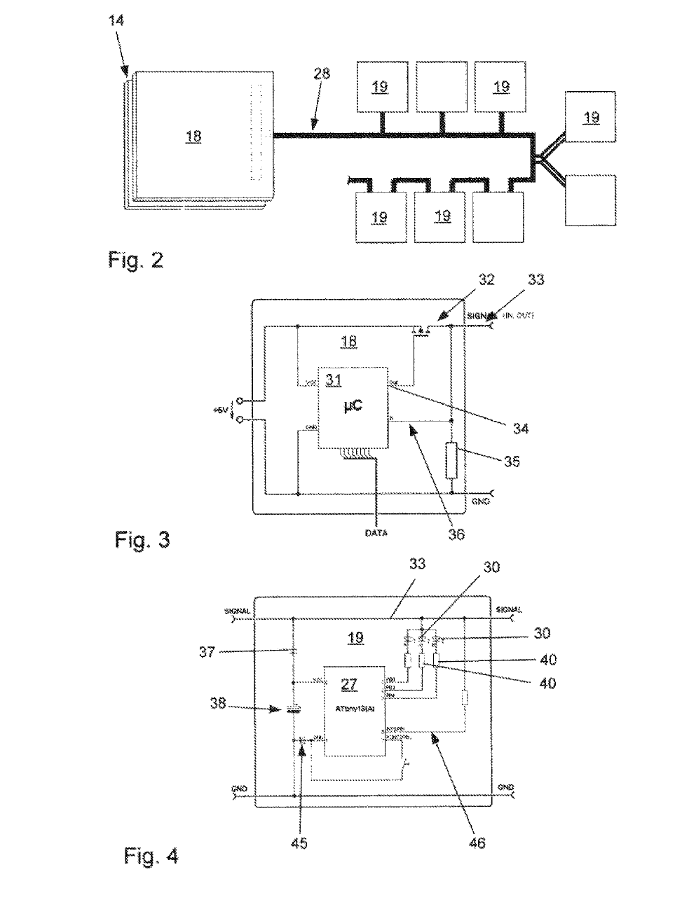

FIG. 2 shows a schematic illustration of the device of the gaming machine shown in FIG. 1,

FIG. 3 shows a schematic illustration of a master of the device,

FIG. 4 shows a schematic illustration of a slave of the device,

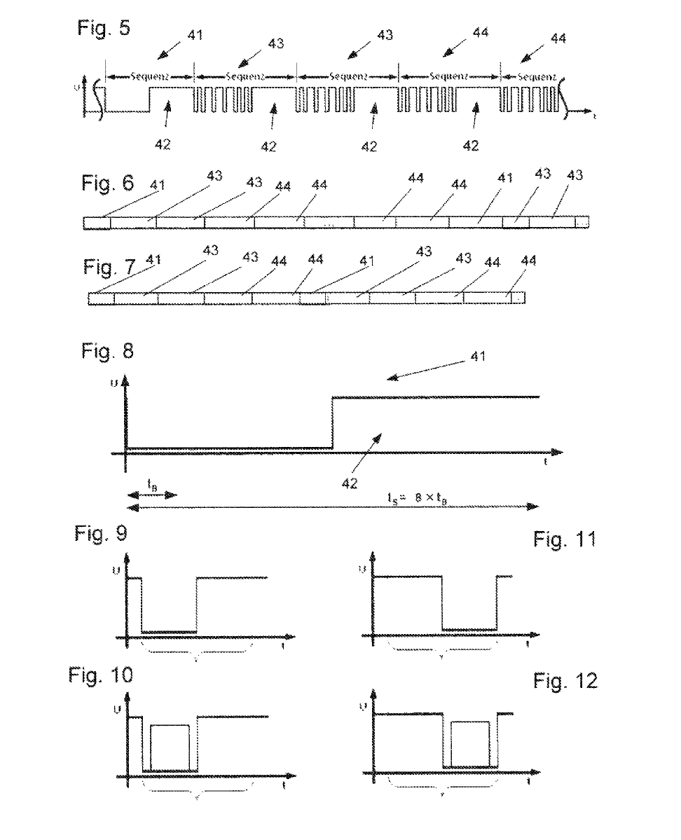

FIG. 5 shows a schematic illustration of a protocol according to which a method that is used to operate the device is executed,

FIG. 6 shows a schematic illustration of a flow of individual sequences of the protocol,

FIG. 7 shows a schematic illustration of a simplified flow of the individual sequences of the protocol,

FIG. 8 shows a schematic illustration of a synchronization start signal,

FIG. 9 to FIG. 12 show schematic illustrations of signals and useful bit groups used, with and without return by a slave,

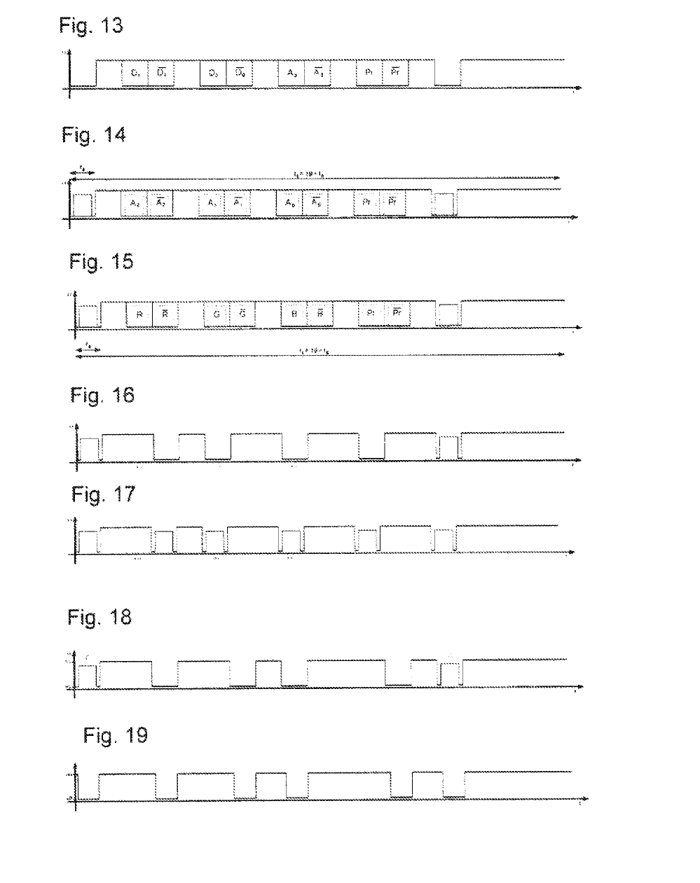

FIG. 13 shows a schematic illustration of a first broadcast signal,

FIG. 14 shows a schematic illustration of a second broadcast signal,

FIG. 15 to FIG. 18 show schematic illustrations of device signals, and

FIG. 19 shows a schematic illustration of a timing for the actuation of LEDs by the slaves.

The front of the housing 1 of the coin-operated, computer-controlled gaming machine with a winnings opportunity has three display devices 26, arranged above one another, in the form of screens 2, the top screen 2 of which is used to present a gaming device 3 that is visually presented in the form of a symbol gaming device with three revolving bodies 4 in cylindrical form that are arranged next to one another. Computer control is used to produce an image that corresponds to rotating revolving bodies 4 with circumferential symbols 5. Furthermore, computer control is used to present reading windows 6 on the screen 2, which are used to display a randomly controlled game result, that is to say a particular combination of symbols 5. The presentation of the game result is accompanied by a display of the virtual revolving bodies 4 that corresponds to stopped cylinders. From the displayed symbols 5, the user can read off the game result, and particularly also whether there are winnings based on a displayable winnings plan.

The screen 2 in the center of the amusement machine is in the form of a touchscreen 25 and is used to present supplementary gaming devices 9 in the form of gamble ladders 7, 8. The winnings attained in the gaming device 3 by achieving a symbol combination ascertained under random control can be transferred under key or computer control as a stake to one of the supplementary gaming devices 9 arranged on both sides of the central screen 2. The left-hand gamble ladder 7 comprises a plurality of display panels 10, presented above one another, that are assigned winnings values from 10 to 5000 points in rising order. The right-hand gamble ladder 7 likewise has a plurality of display panels 10, presented above one another, that are assigned winnings values from 15 to 6000 points in rising order.

The winnings displayed in the gamble ladder 7 or 8 are gambled by virtue of the next highest display panel 10 in relation to the visually highlighted display panel 10 that displays the winnings being presented so as to flash alternately with a total loss display panel 11 labeled “0” that is placed below the gamble ladder 7 or 8. When a key 12 in the form of a momentary contact switch is operated, the pushbutton switch 15 of said key being arranged in a lower housing section 13, either the next highest winnings are attained or the staked winnings are lost, under random control. This process can be continued at points until the maximum winnings presented are reached.

The lower screen 2 is provided with displays 20 for credits, points, winnings and the like, with one of the displays 20 representing a points bank 16. When there is a credit in a display 20 embodied as a credit display 17, a particular sum of money from the credit display 17 is converted into a particular number of points and added to the points bank 16, from which a particular number of points are debited as a stake for a game in the gaming device 3 and to which points won in the gaming device 3 are added. When a cash value is paid out, the points value in the points bank 16 is first of all converted into a credit in a prescribed time interval, said credit being able to be presented in the credit display 17.

The lower housing section 13 of the gaming machine contains restart/stop keys, in a form of momentary contact switches 21, with appropriate pushbutton switches 15 that, when pushed, can be used to restart or prematurely stop that symbol 5 of the associated revolving body 4 that is displayed in the gaming device 3, i.e. the display is influenced such that the revolving bodies 4 appear in a stationary or rotating form. Naturally, all pushbutton switches 15 can be backlit, preferably in color, particularly on the basis of the game flow. In addition, a coin insertion slot 22 and a banknote feed slot 23 of a cash processing device—not shown in more detail—are provided. Furthermore, the coin insertion slot 22 has a return key 24 arranged next to it, operation of which allows a credit displayed in the credit display 20 to be withdrawn to a dispensing tray, which is not shown, the return key 24 likewise having an associated pushbutton switch 15.

In order to introduce fast and inexpensive changes in the design phase of the gaming machine or during the production of variants, for example, a controller 14 coupled to the game flow control is provided that is connected to a master 18 that uses a two-wire connection 28 to communicate with input and output elements 29, in the form of slaves 19, which comprise the pushbutton switches 15 and LEDs 30 for illumination.

The master 18 has a microcontroller 31 and a MOSFET 32. The supply of power to the slaves 19 is provided via a signal line 33 and is briefly disconnected at particular intervals of time by the data output 34 of the master 18 via the MOSFET 32 in switch mode, after which the voltage is at a low level that is subsequently also called 0-bit. During the period of time in which the voltage is disconnected, a pull down resistor 35 pulls the signal line 33 to the defined low ground level. When the signal level of one or more slaves 19 is subsequently raised after a particular time, this is a response (feedback) from at least one slave 19, the response being detected by the master 18 via the data input 36. Since only one pull down resistor 35 of the master 18 is existent and not every slave 19 has an associated resistor, there is no need for a high current for a response from the slaves 19, contrary to the prior art.

Each slave 19 associated with a pushbutton switch 15 comprises a microcontroller 27 for control, said microcontroller being connected to the signal line 33, which is in turn connected to a diode 37 in the form of a Schottky diode, via which a capacitor 38 is charged that serves as a buffer in order to continue to supply power to the microcontroller 27 during the low level phases (0 bits). The polarity reversal protection is implemented with the diode 45, which is arranged such that the slave 19 can continue to raise the signal level on the signal line 33. LEDs 30 of the slave 19, which LEDs are associated with the pushbutton switches 15 for backlighting, are constantly connected to the signal line 33 by means of their anodes. The LEDs 30 are switched on by the microcontroller 27 by virtue of their cathodes being pulled to ground via a respective series resistor 40. During a 0-bit signal from the master 18, the LEDs 30 are not supplied with power and do not light, this being negligible and imperceptible to the human eye on account of the short period of time.

The brightness or the duty ratio on the signal line 33 is constant and independent of the useful data sent, as a result of the redundant design of the protocol.

There is a defined time window in which the LEDs 30 of all the slaves 19 are off and a 0-bit signal is applied to the signal line 33. During this time, the data input/output pin 46 of the slave 19 that is used to perform the evaluation, which pin is connected as an input, can be changed over as an active output and can raise a signal at a level amounting to the charged capacitor 38 for a short time. In the same time window, the master 18 samples the signal line 33, which provides the slave 18 with the opportunity to send a bit to the master 18.

As FIG. 5 shows, the data are packed into signals comprising individual data packets, said signals subsequently also being called sequences. The order of the signals determines to whom the data are sent. The first sequence is always a synchronization start signal 41, also called SYNC sequence (FIG. 8), and, in contrast to the other sequences, comprises only 8 bits and defines the starting point for the transmission, which starting point is very easy to detect, since this is the only case in the entire transmission in which there is a LOW bit on the signal line 33 four times in succession, as a result of which it is possible for a timer to process this point in the associated interrupt routine independently of a main program.

The synchronization start signal 41 ends, like all other sequences, by virtue of there being a high bit on the signal line 33, called μSYNC 42, four times in succession. This series can, like the low bit series, be easily detected and processed by means of the timer and the associated interrupt routine. The μSYNC 42, which involves 4 bits in succession being sent at a high level, that is to say with the voltage switched on, separates the individual sequences from one another, which is why this data sequence is called a separating signal 42.

According to FIG. 6, the datastream sent by the master 18 can be essentially split into three different sequences, namely the synchronization start signal 41, that is to say what is known as the SYNC sequence, the broadcast signals 43 sent to all the slaves 19, which broadcast signals comprise data in a signal sequence that relate to each slave 19, and the device signals 44 sent to particular slaves 19, which device signals are naturally also implemented in the form of sequences.

The entire transmission time and hence the reaction time can be reduced by the number of slaves 19 used, with either, according to FIG. 6, a device signal 44 being sent to all the possible slaves 19 or, according to FIG. 7, a device signal 44 being sent for a reduced number of slaves 19.

Specifically, each bit has a duration of 25 μs, with the synchronization start signal 41, that is to say the SYNC sequence, comprising 8 bits, and the two broadcast signals 43 and each of the device signals 44 comprising 19 bits, as a result of which the total duration of a transmission with 16 device signals 44 is 8.75 ms.

The two broadcast signals 43 and each of the device signals 44 comprise(s) 19 bits. The first and fifteenth bits are always 0. Feedback from the slaves 19 by raising the signal level in these two time phases indicates that the slaves 19 are existent. Since the broadcast signals 43 and the device signals 44 each comprise a fixed number of positive edges, that is to say high bits, simple counting of the edges allows the end of the relevant sequence to be found without the μSYNC 42 being present. If the μSYNC 42 is present and the number of positive edges is counted, the end of the sequence is found redundantly.

The second, fifth, eighth, eleventh and fourteenth bits are always 1. In between there are useful bits with their redundancies. The sequence is completed by the μSYNC 42, that is to say the separating signal 42, with four bits that are 1. The useful bits are always sent in groups of two, that is to say the useful bit itself followed by the inverted useful bit (FIG. 9 to FIG. 12), with the last group of two indicating the parity bit. If the number of useful bits that are 1 is even, the parity bit is set. Since precisely one bit in each group of two is 1 and the other is 0, the slave 19 can raise the level (FIG. 10 and FIG. 12), that is to say send a bit to the master 18, in this 0 phase.

FIGS. 9 to 12 show the four possibilities for a group of two. According to FIG. 9, the master 18 returns the useful bit that is set at 0 and the slave 19 does not return a bit that is set at 1 to the master 18. FIG. 10 shows a signal profile in which the slave 19 returns the bit set at 1 to the master 18 in the 0 phase of the useful bit from the master 18 that is set at 0. According to FIG. 11, the master 19 returns the useful bit that is set at 1 and the slave 19 does not return a bit that is set at 1 to the master 18 while the inverted useful bit is 0. According to FIG. 12, the master 19 again returns the useful bit that is set at 1 and the slave 19 returns the bit that is set at 1 to the master 18 at the time by which the inverted useful bit is 0.

According to FIGS. 13 and 14, the broadcast signals 43 contain the databits D1 and D0 that indicate one of four operating states. On the basis of this, either A3 to A0 correspond to a 4-bit address or A2 to A0 contain RGB data for the LEDs 30, which means that the second broadcast signal 43 takes on the function of a device signal 44 that is sent to all the unconfigured slaves 19. If the second broadcast signal 43 is attributed the function of the device signal 44, the addressed slaves 19 can provide feedback in this case too, as illustrated by the dotted lines. If the data bits A3 to A0 contain a 4-bit address and the relevant operating state “device programming” is selected by means of D0 and D1, a new address (device ID) that is described by the data bits A3 to A0 is allocated when the pushbutton switch 15 of a slave 19 is pressed.

The device signal 44 addresses the slaves 19 that are associated with the current device sequence 44 by means of their identification. This means that the first device signal 44 after the broadcast signals 43 addresses the slaves 19 with the device ID 0, the next device sequence 44 addresses the slaves 19 with device ID 1, etc.

The device signal 44 contains the information regarding which LEDs 30 are actuated in what way and prescribes for the slave 19 time windows in which feedback is provided concerning whether a slave 19 with the relevant device ID is existent and whether the pushbutton switch 15 associated with the device ID has been operated. Up to three different LEDs 30 or one RGB LED 30 can be actuated. In the case of the RGB LED 30, the single LEDs are actuated in accordance with the following table:

| Bit/level | LOW | HIGH |
|---|---|---|
| R | Switch off red LED | Switch on red LED |
| G | Switch off green LED | Switch on green LED |
| B | Switch off blue LED | Switch on blue LED |

The LEDs 30 are actuated on the basis of the protocol design such that a constant brightness for the observer is attained.

FIG. 16 shows the level of a device signal 44 on the signal line 33 when the red LED 30 is meant to be on, the green and blue LEDs 30 are meant to be off and the pushbutton switch 15 is connected but not operated. According to FIG. 17, the red LED 30 is on, the green and blue LEDs 30 are off and the pushbutton switch 15 is connected and operated.

In all time windows in which a slave 19 could send feedback to the master 18, each slave 19 needs to switch off all the LEDs 30 so that the signal line 33 is free of load.

Only HIGH levels are actively transmitted by the master 18 and LOW levels correspond to the ‘standard’ state of the signal line 33 and are applied only (for approximately 25 μs) when no feedback is provided by a slave 19, otherwise a HIGH level produced by the feedback can be applied again just shortly after the falling edge of the HIGH level. It is thus not possible for the data on the signal line 33 to be sampled in the middle of the time window of a bit. Instead, the instant of the falling edge of the HIGH level needs to be used in order to detect which bits are 0.

FIG. 18 shows a level profile for the signal line 33 and FIG. 19 shows the associated control state of the LEDs 30.

### LIST OF REFERENCE SYMBOLS

| | |
|---|---|
| 1. | Housing |
| 2. | Screen |
| 3. | Gaming device |
| 4. | Revolving body |
| 5. | Symbol |
| 6. | Reading window |
| 7. | Risk ladder |
| 8. | Risk ladder |
| 9. | Supplementary gaming |
| | device |
| 10. | Display panel |
| 11. | Total loss display |
| | panel |
| 12. | Key |
| 13. | Housing section |
| 14. | Controller |
| 15. | Pushbutton switch |
| 16. | Points bank |
| 17. | Credit display |
| 18. | Master |
| 19. | Slave |
| 20. | Display |
| 21. | Momentary contact |
| | switch |
| 22. | Coin insertion slot |
| 23. | Banknote feed slot |
| 24. | Return key |
| 25. | Touchscreen |
| 26. | Display device |
| 27. | Microcontroller |
| 28. | Two-wire connection |
| 29. | Input and output |
| | element |
| 30. | LED |
| 31. | Processor |
| 32. | MOSFET |
| 33. | Signal line |
| 34. | Data output |
| 35. | Pull down resistor |
| 36. | Data input |
| 37. | Diode |
| 38. | Capacitor |
| 39. | |
| 40. | Series resistor |
| 41. | Synchronization |
| | start signal |
| 42. | Separating signal |
| 43. | Broadcast signal |
| 44. | Device signal |
| 45. | Diode |
| 46. | Data input/output |
| | pin |

1.-12. (canceled)

13. A gaming machine having at least one computer-controlled gaming device that is connected to a game flow control, wherein a device for controlling input and output elements is provided, wherein the device comprises a controller that is coupled to the game flow control and that is connected to a master that communicates via a two-wire connection in real time with input and output elements in the form of slaves, wherein the slaves are physically connected in parallel.

14. The gaming machine as claimed in claim 13, wherein the slaves are connected to the master with polarity reversal protection and/or short circuit protection by means of a diode.

15. The gaming machine as claimed in claim 13, wherein the slaves each comprise a microcontroller and are in programmable form.

16. The gaming machine as claimed in claim 13, wherein each slave comprises a pushbutton switch and/or one or more LEDs, particularly RGB LEDs and/or arbitrary actuators and/or arbitrary sensors.

17. The gaming machine as claimed in claim 13, wherein the input elements are in the form of pushbutton switches and the output elements are in the form of light-emitting diodes, particularly RGB LEDs, associated with the pushbutton switches.

18. The gaming machine as claimed in claim 13, wherein each slave has an associated capacitor for supplying power to a microcontroller.
